(19) United States
(12) Patent Application Publication
(10) Pub. No.: US 2024/0284579 A1
(43) Pub. Date: Aug. 22, 2024

(54) NON-RADIOISOTOPE X-RAY DEVICE

(71) Applicant: Xelera Research LLC, Ithaca, NY (US)

(72) Inventors: Bruce Dunham, Redwood City, CA (US); John Scott Price, Niskayuna, NY (US)

(21) Appl. No.: 18/582,963

(22) Filed: Feb. 21, 2024

Related U.S. Application Data
(60) Provisional application No. 63/447,184, filed on Feb. 21, 2023.

(51) Int. Cl. H05G 1/02; H01J 35/06; H01J 35/16

(52) U.S. Cl. CPC H05G 1/025; H01J 35/06; H01J 35/16; H01J 2235/1216

(57) ABSTRACT

An x-ray device may include a target that emits x-rays when subjected to electrons, an electron source configured to emit electrons toward the target, an elongated annular first shell connected to and supporting the electron source, and an elongated annular second shell connected to and supporting the target. The first shell and the second shell may be arranged one radially inside the other.

### CROSS-REFERENCE TO RELATED APPLICATIONS

This application claims priority to U.S. Provisional Patent Application No. 63/447,184, filed on Feb. 21, 2023, the contents of which is hereby incorporated by reference in its entirety.

### TECHNICAL FIELD

The present disclosure generally relates to non-radioisotope-based x-ray devices.

### BACKGROUND

The development of non-radioisotope-based radiation (e.g., x-ray) sources is an important part of the national effort to reduce reliance on radioisotopes, advance nuclear non-proliferation, and address waste concerns. Radioisotope sources may also pose a security risk. Non-radioisotope sources of radiation (e.g., x-rays) are thus of great interest. However, progress in this area has been slow due to a lack of comparable replacements.

There has been substantial effort in development of non-radioisotope radiation devices for a wide range of applications. These non-radioisotope radiation devices typically involve bombarding a material with electrons, protons, and/or ions. The interaction of the electrons, protons, and/or ions with the material results in the production and/or emission of radiation (e.g., x-rays, gamma rays) that may be used in place of radiation from radioisotope sources. Such non-radioisotope radiation devices may be convenient to use and can produce neutrons and/or high energy x-rays and gamma rays to, for example, irradiate medical wastes, sterilize food items, and interrogate oil-well integrity.

There are many applications for x-ray irradiation such as medical product sterilization, blood irradiation, insect sterilization, mail sterilization, oil-well inspection, medical imaging, and water treatment for example. Traditional x-ray devices have been in existence for over a century, using an electron beam impinging on either fixed or rotating targets to produce a broad spectrum of x-rays with modest endpoint energies. Second generation or ‘flat panel’ x-ray devices were conceived in the late 1990s, using an extended electron beam source and flat panel transmission target to generate a flood of x-rays, or an addressable emitter to effectively scan the x-ray beam without physical moving it. However, some x-ray devices may not be able to effectively and/or efficiently meet the needs for various industrial applications, which often require an x-ray device that is capable of enduring harsh environments such as high temperatures, high pressures, liquid environments, and/or restricted geometries/operational space for example.

Accordingly, there is a need for an innovative and improved non-radioisotope-based x-ray device that minimizes or eliminates one or more challenges or shortcomings of existing non-radioisotope-based x-ray devices.

### SUMMARY

An x-ray device may include a target that emits x-rays when subjected to electrons, an electron source configured to emit electrons toward the target, an elongated annular first shell connected to and supporting the electron source, and an elongated annular second shell connected to and supporting the target. The first shell and the second shell may be arranged one radially inside the other.

An x-ray device may include an elongated annular first shell, an elongated annular second shell, a target that emits x-rays when subjected to electrons, an electron source configured to emit electrons toward the target, and a cooling jacket arranged on and connected to the second shell. The first shell and the second shell may be arranged one radially inside the other. An annular vacuum space may be defined by and radially between the first shell and the second shell. The target may be disposed in the vacuum space and connected to the second shell. The electron source may be disposed in the vacuum space and connected to the first shell. The second shell may be disposed radially between and separate the target and the cooling jacket. An annular fluid chamber through which a coolant is flowable may be at least partially defined by and radially between the cooling jacket and the second shell. The x-ray device may further include an internal cavity may be circumferentially surrounded by the first shell, the second shell, the electron source, the target, and the cooling jacket.

An x-ray device may include a target that emits x-rays when subjected to electrons, an electron source configured to emit electrons toward the target, an elongated annular first shell connected to and supporting the electron source, and an elongated annular second shell connected to and supporting the target. The first shell and the second shell may be arranged one radially inside the other. The electron source may be disposed on an inner circumferential surface of the first shell and the target may be disposed on an outer circumferential surface of the second shell. Alternatively, the electron source may be disposed on an outer circumferential surface of the first shell and the target may be disposed on an inner circumferential surface of the second shell.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a partially exploded, perspective view of an exemplary x-ray device configured to emit electrons in a radially inward direction;

FIG. 2 is a cross-sectional view of a portion of the x-ray device of FIG. 1;

FIG. 3 is a cross-sectional view of a portion of an exemplary x-ray device configured to emit electrons in a radially outward direction;

FIG. 4 is a partial cross-section, perspective view of a portion of an exemplary x-ray device configured to emit electrons in a radially inward direction and tailored for radially inward irradiation being used in conjunction with a conveyor;

FIG. 5A is a partial cross-section, perspective view of a portion of an exemplary x-ray device configured to emit electrons in a radially outward direction and tailored for radially outward irradiation being used for, in the illustrated example, oil-well inspection;

FIG. 5B is a close up view of a portion of FIG. 5A; and

FIG. 6 is a cross-sectional view of a portion of another exemplary x-ray device configured to emit electrons in a radially inward direction and including shells with non-circular geometries.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

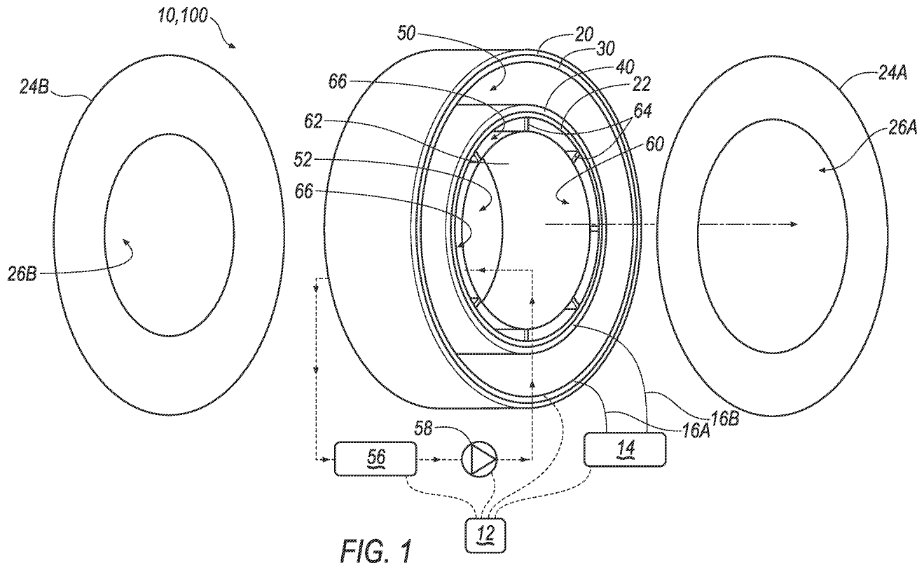

Referring to FIG. 1, an x-ray device 10 includes a controller 12, a power source 14, a plurality of shells 20, 22, a plurality of covers 24A, 24B, an electron source 30 that emits electrons, a target 40, a vacuum space 50, and an internal cavity 52. Optionally, the x-ray device 10 includes a heat exchanger 56, a pump 58, and a cooling jacket 60. The controller 12 is operatively (e.g., communicatively, electrically, and/or physically) connected to the power source 14, the electron source 30, the heat exchanger 56, and the pump 58. The controller 12 is configured to control and/or operate the power source 14, the electron source 30, the heat exchanger 56, the pump 58, and/or the x-ray device 10 as a whole. The power source 14 is physically and electrically connected to the electron source 30 and the target 40, such as by one or more conductors 16A, 16B. The power source 14 is configured to provide power and/or electricity to the electron source 30 and the target 40 to the establish a voltage differential therebetween.

The electron source 30, which may be commonly known and/or referred to as a cathode, is configured to emit electrons 70. The target 40, which may be commonly known and/or referred to as an anode, is configured to emit x-rays 72 when subjected to (e.g., contacted, impinged, and/or bombarded by) electrons 70. During operation, electrons 70 are emitted from the electron source 30 (i.e., the cathode) and directed across the vacuum space 50 toward the target 40 (i.e., the anode) due to a voltage differential provided and/or established between the electron source 30 and the target 40 by the power source 14. The electrons 70 contact, impact, and/or impinge on the target 40 resulting in the emission of x-rays 72 from the point of impact (e.g., due to the sudden, rapid deceleration of the electrons 70). The emitted x-rays 72 can then be utilized as desired, such as for sterilization, inspection, medical imaging, and/or other commonly known uses.

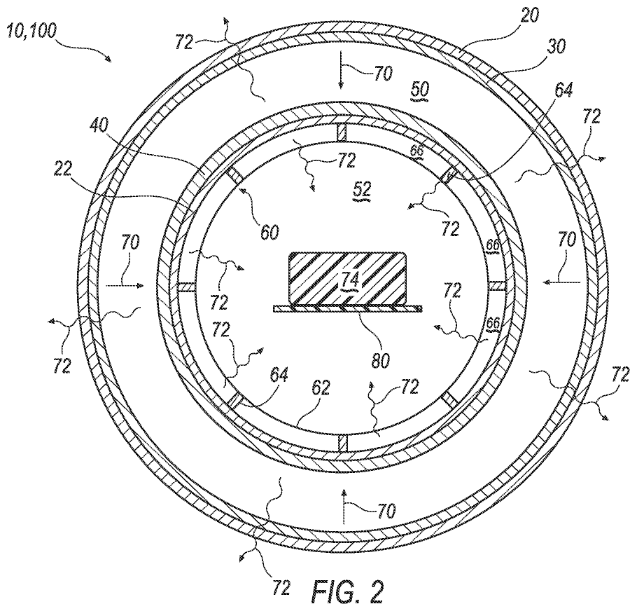

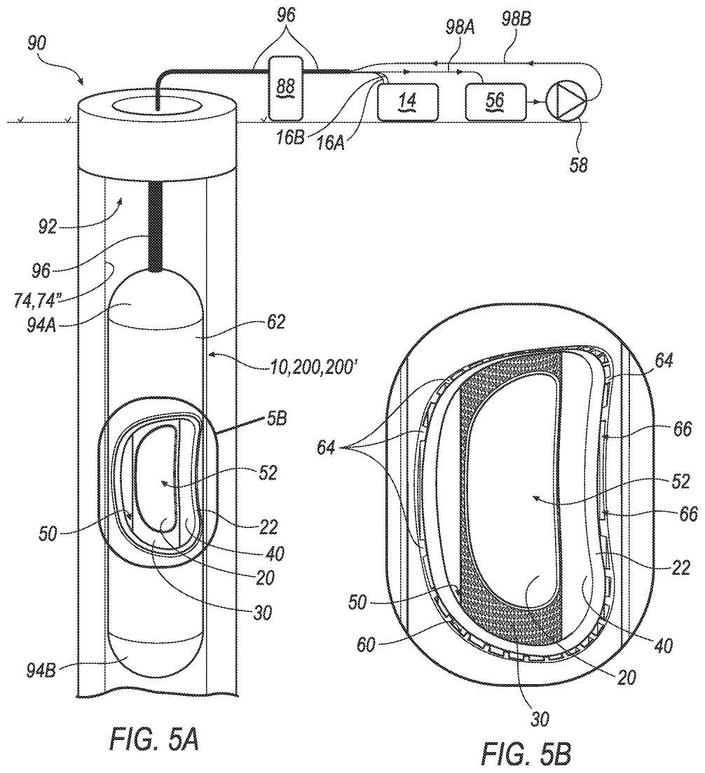

The internal cavity 52 is disposed radially inward of and circumferentially surrounded by the shells 20, 22, the electron source 30, the target 40, and the cooling jacket 60. In some examples (see, e.g., FIGS. 1-4 and 6), one or more axial ends of the internal cavity 52 are open and an object 74 for irradiation is movable into and/or out of the internal cavity 52. Several objects 74 for irradiation and a conveyor 80 extending through the internal cavity 52 are depicted in FIGS. 2, 3, 4, and 6 for illustrative purposes. In other examples (see, e.g., FIGS. 5A and 5B), the axial ends of the internal cavity 52 are closed and an object 74 for irradiation is not movable into and/or out of the internal cavity 52.

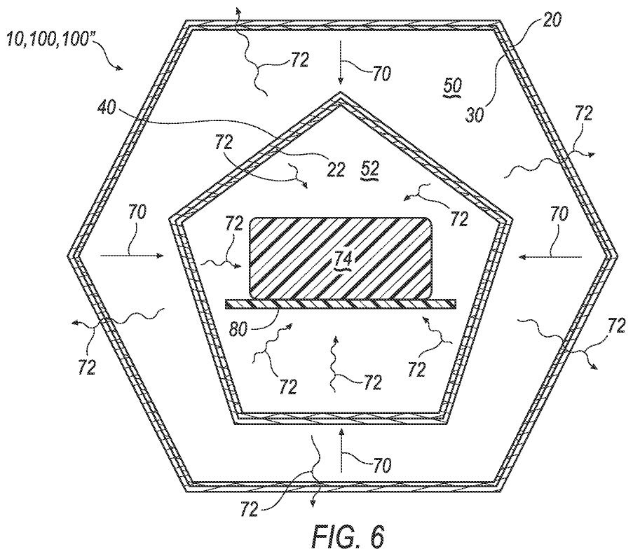

As generally illustrated in FIGS. 1-6, the plurality of shells includes a first shell 20 and a second shell 22 that are arranged one radially inside the other. More specifically, in one example the first shell 20 and the second shell 22 are arranged coaxially and/or concentrically. The shells 20, 22 are elongated annular (i.e., ring and/or tube shaped) bodies that are connected to one another at their axial ends by the covers 24A, 24B. The shells 20, 22, together with the covers 24A, 24B, define and/or form an elongated annular vacuum space 50. The shells 20, 22 each have and/or define a circular cross-sectional profile and/or shape in FIGS. 1-5, which has been found to be advantageous and/or ideal for large-area electron bombardment. Nevertheless, one or more of the shells 20, 22 may alternatively have and/or define other cross-sectional profiles and/or shapes, such as an elliptical, hexagonal, or octagonal profile and/or shape for example (see, e.g., FIG. 6). Additionally, while the shells 20, 22 have and/or define the same cross-sectional profile and/or shape in the illustrative examples depicted in FIGS. 1-5, the shells 20, 22 may alternatively have and/or define different cross-sectional profiles and/or shapes than one another (see, e.g., FIG. 6).

The first shell 20 is connected to and supports the electron source 30. The second shell 22 is connected to and supports the target 40. The second shell 22 is also connected to the cooling jacket 60, which is disposed on the radially opposite side of the second shell 22 from the target 40. In other words, the second shell 22 is disposed radially between and/or separates the target 40 and cooling jacket 60 from one another. The second shell 22 is contacted and/or (e.g., by means of a seal) connected to the cooling jacket 60 such that a fluid chamber 66 is defined by and disposed between the second shell 22 and the cooling jacket 60.

As generally illustrated in FIG. 1, the plurality of covers 24A, 24B includes a first cover 24A and a second cover 24B. The covers 24A, 24B include and/or are composed at least partially of one or more insulating materials to maintain a voltage differential between the electron source 30 and the target 40. In other words, the covers 24A, 24B are high voltage (HV) insulators and may be referred to as HV insulator covers. The covers 24A, 24B are generally planar and/or disc shaped bodies. The covers 24A, 24B each include and/or define a through opening 26A, 26B and are thus annular shaped (i.e., annular covers 24A, 24B). Conceivably, in suitable configurations of the x-ray device 10, such as those in which the x-ray device 10 is tailored for radially outward irradiation (see, e.g., FIG. 6), the covers 24A, 24B may not include and/or define through openings 26A, 26B and may close the axial ends of the internal cavity 52. The covers 24A, 24B are disposed on and connected to opposite axial ends of the shells 20, 22. In this way, the covers 24A, 24B provide structural support to the shells 20, 22. The shells 20, 22 extend and/or project axially from the covers 24A, 24B. One of the first shell 20 and the second shell 22 extends circumferentially around the outer perimeter of each cover 24A, 24B. The other of the first shell 20 and the second shell 22 extends circumferentially around the inner perimeter (e.g., the through opening 26A, 26B) of each cover 24A, 24B. The covers 24A, 24B extend radially between the shells 20, 22 and close the axial ends of the radial gap between the shells 20, 22 such that an elongated annular vacuum space 50 is (i) defined radially by and between the shells 20, 22 and (ii) axially by and between the covers 24A, 24B.

As generally illustrated in FIGS. 1-6, the elongated annular vacuum space 50 is disposed and/or formed between the shells 20, 22 and covers 24A, 24B. More specifically, the vacuum space 50 is (i) defined radially by and/or between the shells 20, 22 and (ii) axially by and/or between the covers 24A, 24B. At least a portion of the vacuum space 50 is disposed between and separates (e.g., radially) the electron source 30 and the target 40. The radial dimension of the vacuum space 50 (i.e., the radial distance between the electron source 30 and the target 40) may vary based on the voltage. The radial dimension of the vacuum space 50 may, for example, range from as little as 4 mm up to a few centimeters (e.g., when a 120 kV electron beam is used). The vacuum space 50 is sealed and is maintained without active pumping, which facilitates use of the x-ray device 10 in the field (e.g., since the x-ray device 10 is more portable). Additionally and/or alternatively, the x-ray device 10 may include and/or may be connectable to one or more vacuum pumps 58 (e.g., a solid-state pump, such as a non-evaporable getter or “NEG” pump) to establish and/or maintain the vacuum within the vacuum space 50.

Commonly referred to in the industry, the anode-cathode voltage may be referred to as the ‘tube voltage’, and is the cathode-anode voltage difference. Typically, the cathode is at a relatively high negative and the anode is at ground. The electrons leave the cathode, and accelerate through the “tube voltage”. Once at the anode (i.e., the target 40) the electrons are at energy e*V. Thus, in one example an electron accelerated through 120 kV has energy 120 keV.

As generally illustrated in FIGS. 1-6, the electron source 30 is disposed in the vacuum space 50 and is connected to and/or mounted on the first shell 20. The electron source 30 (i.e., the cathode) is configured to emit electrons 70 (e.g., from the electron-emitting surface) through the vacuum space 50 toward the target 40. The electrons 70 are emitted from the electron source 30 at near-0 energy (e.g. a few electron-volts (or eV) energy). The electrons 70 are accelerated across the vacuum space 50 by the electric field between the electron source 30 and the target 40. The electric field is approximately E=V/d, where E=electric field strength, V=voltage difference between the electron source 30 and the target 40, and d=distance between the electron source 30 and the target 40. The electron source 30 is configured to focus the emitted electrons 70 toward and/or onto the target 40. Additionally, the electron source 30 emits a uniformly cylindrical distribution of electrons 70 during operation. In one example, the electron source 30 emits electrons 70 in the form of one or more electron beams. The electron source 30 emits electrons 70 that are accelerated to 120 keV (i.e. 120 keV energy electrons), but the emitted electrons 70 may be accelerated to an energy other than 120 keV depending upon the voltage difference between the cathode 30 and anode 40. In one example, the emission current density of the electron source 30 is of order 1 mA/cm². Additionally and/or alternatively, emission current density is of order 100 μA/cm². The emission current density increases as the ratio of the shell diameters, (OD/ID), where OD is an outer diameter and ID is an inner diameter as further set forth below. The electrons 70 and/or electron beam emitted by the electron source 30 incident upon the surface of the anode/target 40 have an incident electron beam power of the beam current, in mA, and electron energy 120 keV. In one example, the incident electron beam power is 10 mA*120 keV or 1,200 W at the target 40.

According to the disclosure, the emission current density is important because it influences, impacts, and/or determines heating and cooling of the target 40. In configurations of the x-ray device 10 with cylindrical shells 20, 22, electron source 30, and target 40, the emission current density (i.e., electron current in mA/area of electron beam in cm2) increases as the ratio of the shell diameters (OD/ID) increases. Here, OD refers to the outer diameter of the vacuum space 50 and ID refers to the inner diameter of the vacuum space 50. The OD is defined by one of (i) the electron-emitting surface of the electron source 30 and (ii) the surface of the target 40 that is impacted by the electrons 70, and the ID is defined by the other of (i) the electron-emitting surface of the electron source 30 and (ii) the surface of the target 40 that is impacted by the electrons 70.

The above discussion assumes a general cylindrical geometry of two nested cylinders. When the electrons collide with the anode/target surface x-rays are emitted, with the different combinations and configurations down to the described example. The word ‘shell’ in the sentence refers to the ideal geometry of two concentric or nested cylinders that have no thickness or ‘shell’-like, thus OD=electron emitter and ID=target. Thus, the electron density is electron current (mA)/area of beam (cm\hat{ }2). It is important since heating of the target and cooling of the target are determined by the current density, mA/cm\hat{ }2. Since the area of a right-circular cylinder is circumference (pi*D) times length (L), the area is pi*OD*L (for electron emitting outer cylinder) and pi*ID*L (for anode or target inner cylinder) then the ratio of the two areas is (OD/ID).

In one example the cathode is a carbon nanotube (CNT) electron emitter, which is a field emitter (E-field at the surface produces emission of electrons). According to one example, the emitter emits at 1 mA/cm\hat{ }2. At lower E-field lower current density e.g. 10 uA/cm\hat{ }2, 100 uA/cm\hat{ }2 may be experienced. These lower values can be useful if larger surface areas are used, or less intense x-rays fulfill the needs for the device and application, whereas higher E-fields may not produce more electrons without shortening the surface lifetime or provoking arcing in the vacuum. Thus, according to the disclosure the current is selected by varying the E-field by means of adjusting the voltage that is applied across the cathode-anode gap. Further, unlike traditional imaging x-ray sources, a small focal spot may not be desired. The disclosed source is therefore suited for uses such as blood irradiators, food sterilization, and the like. Other examples may include ‘flood’ e-guns that produce broad fields of x-ray illumination. Also, down-hole oil and gas well interrogation tasks can tap the x-rays irradiated by rings of x-ray sources by appropriate positioning of detectors.

The electron source 30 is and/or includes a plurality of electron emitters. The emitters are disposed in the vacuum space 50 and are connected to and/or mounted on the first shell 20. The emitters are typically cold electron emitters to avoid additional heat generation. For example, the electron emitters are carbon nanotube emitters in some examples due to their ability to withstand high temperatures and vibrations. Additionally and/or alternatively, the electron source 30 may be and/or include one or more other kind and/or type of emitter such as a photoemission emitter, thermionic emitter, secondary emitter, and/or field emitter. Optionally, subsets and/or individual emitters of the electron source 30 can be controlled independently (e.g., via the controller 12) to enable different and/or optimal dose patterns to be achieved by utilizing/operating only select emitters during operation of the x-ray device 10.

In one example, carbon nanotube (CNT) emitters may be referred to as ‘cold’ electron emitters. This class of electron emitter does not include elevated temperature at the surface as does tungsten wire coils or dispenser cathodes (thermionic emitters). Another example of room-temperature or ‘cold’ emitters are the photoemission emitters. Thus, assuming a cold emitter technology does not typically include any additional modification. The emission density referred to above, 100 uA/cm\hat{ }2 to 1 mA/cm\hat{ }2 are typical of the cold emission devices like CNTs. Thus, there is not ‘current’ applied to the emitter analogous to a filament for heating, and the current comes from the voltage source or power supply 14 controlled by 12 as set forth in the figures.

As generally illustrated in FIGS. 1-6, the target 40 (i.e., the anode) is configured to emit x-rays 72 when subjected to (e.g., contacted, impacted impinged on, and/or bombarded by) electrons 70. The target 40 generally emits x-rays 72 in all directions (e.g., radially inward and radially outward) when subjected to electrons 70. The electron 70 and/or electron beam power produces emission of x-rays 72 at roughly 1% efficiency, however, and much of the electron 70 and/or electron beam power is lost as heat. The production of x-rays 72 by the target 40 is nearly isotropic at the energy levels utilized by the x-ray device 10.

As generally illustrated in FIGS. 1-6, the target 40 is a layer of material and/or a cylindrical body disposed on and/or connected to a circumferential surface of the second shell 22, and is disposed in the vacuum space 50. The target 40 and/or the material of the target 40 includes and/or is composed at least partially of tungsten (e.g., is a tungsten layer). Additionally and/or alternatively, the target 40 may include and/or may be composed at least partially and/or entirely of another high-Z metal (e.g., refractory metals, such as tantalum (Ta), rhenium (Re), gold (Au), and platinum (Pt)), although precious metals (e.g., gold (Au) and platinum (Pt)) may be less desirable and/or practical for a cost standpoint. Since temperatures are lower for the x-ray device 10 than for high power medical rotating targets with very small focal spots, some material combinations become attractive. The target 40 extends completely around the second shell 22 in the circumferential direction and substantially covers an entity of the axial length of the second shell 22. In other words, the circumferential surface of the second shell 22 may be substantially and/or entirely covered by the target 40. The thickness of the target 40 influences x-ray production efficiency. The target 40 has a radial thickness of approximately 22 μm since, in the geometry of the x-ray device 10, radial thicknesses greater than 22 μm have been found to result in significant self-absorption (i.e., significant x-ray 72 absorption by the target 40). Other radial thicknesses of the target 40 are conceivable, however. The best and/or ideal radial thickness for the target 40 depends upon several factors, such as (i) the energy of the electrons 70 upon collision with the target 40 (e.g., the voltage applied between cathode 30 and anode 40) and the composition/material of the target 40 (particularly its density and Z or atomic number).

As generally illustrated in FIGS. 1-5, the cooling jacket 60 conducts cooling fluid and/or coolant to cool the target 40 and the second shell 22. An incident electron beam power of approximately 1 kW is incident upon the target 40 during operation. Due to the inefficiency of the x-ray production process, a vast majority (e.g., nearly all) of this power is lost as heat. This heat is conducted from the target 40 to the second shell 22 and dissipated by the cooling jacket 60 and the coolant flowing therethrough.

The cooling jacket 60 includes a jacket shell 62, a plurality of support members 64, an inlet, and an outlet. The cooling jacket 60 is connected to the second shell 22 and at least partially defines a (e.g., annular) fluid chamber 66 through which a coolant is flowable. The cooling jacket 60, by way of the inlet and outlet, is connected to and in fluid communication with the heat exchanger 56 and the pump 58 forming a cooling circuit. Coolant is flowed and/or pumped through the fluid chamber 66 and the heat exchanger 56 by the pump 58 to actively cool the target 40 and the second shell 22. During operation of the x-ray device 10, hot and/or heated coolant that has absorbed heat from the target 40 (via the second shell 22) is discharged from the fluid chamber 66 via the outlet, flows to and through the heat exchanger 56 where it is cooled, and is pumped back to and into the fluid chamber 66 via the inlet.

The jacket shell 62 is an elongated annular (i.e., ring and/or tube shaped) body that is arranged coaxially and concentrically with the first shell 20 and the second shell 22. The jacket shell 62 has and/or defines a cross-sectional profile and/or shape corresponding and/or matching that of the second shell 22 (e.g., a circular cross-sectional profile and/or shape), but may conceivably have a cross-sectional profile and/or shape differing from that of the second shell 22. The jacket shell 62 is disposed radially spaced apart from the second shell 22 such that the fluid chamber 66 is formed and/or defined by and radially between the jacket shell 62 and the second shell 22. The axial ends of the fluid chamber 66 are closed by one or more portions of the jacket shell 62 (e.g., flanges and/or axial end walls), which include the inlet and outlet. Conceivably, the covers 24A, 24B and/or one or more other bodies (e.g., lids) may include the inlet and/or outlet and close the axial ends of the fluid chamber 66.

The support members 64 are connected to and extend (e.g., radially) between the jacket shell 62 and the second shell 22. The support members 64 are disposed in the fluid chamber 66 and connect the jacket shell 62 to the second shell 22. The support members 64 also reinforce the jacket shell 62 and/or resist deformation of the jacket shell 62 (e.g., in the radial direction) to mitigate and/or prevent collapse of the fluid chamber 66. At least some of the support members 64 are elongated axial walls and/or projections, and divide and/or separate the fluid chamber 66 into a plurality of axially extending fluid channels and/or regions. Additionally and/or alternatively, at least some of the support members 64 may be structured as turbulators, protrusions, and/or pillars that are distributed throughout the fluid chamber 66 to increase turbulence and/or mixing of the coolant in the fluid chamber 66, which increases heat transfer efficiency and thus improves cooling of the target 40.

The x-ray device 10 may be configured to emit electrons 70 in a radially inward direction as shown in FIGS. 1, 2, 4, and 6. An x-ray device 10 configured to emit electrons 70 in a radially inward direction may be considered and/or referred to as having an inward electron emission configuration 100, as an inward electron emission configuration 100 of the x-ray device 10, as an inward electron emission x-ray device 10, 100, and/or simply as an x-ray device 10, 100 for brevity.

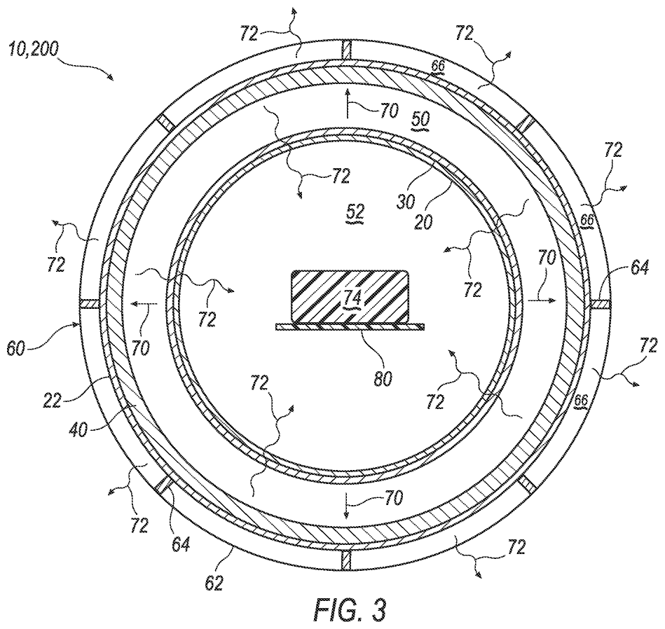

Alternatively, the x-ray device 10 may be configured to emit electrons 70 in a radially outward direction as shown in FIGS. 3 and 5. An x-ray device 10 configured to emit electrons 70 in a radially outward direction may be considered and/or referred to as having an outward electron emission configuration 200, as an outward electron emission configuration 200 of the x-ray device 10, as an outward electron emission x-ray device 10, 200, and/or simply as an x-ray device 10, 200 for brevity.

Regardless of electron emission direction, the x-ray device 10 can be used for both radially inward irradiation and radially outward irradiation. For example, the x-ray device 10 can be used to irradiate an object 74 disposed radially inward of the target 40, such as an object 74 disposed in the internal cavity 52 (i.e., used for radially inward irradiation). The x-rays 72 utilized during radially inward irradiation are primarily the x-rays 72 emitted by the target 40 in the radially inward direction. The x-ray device 10 can also be used to irradiate an object 74 disposed radially outward of the target 40 (i.e., used for radially outward irradiation), such as an object 74 disposed outside of the internal cavity 52 and/or in the surrounding environment of the x-ray device 10. The x-rays 72 utilized during radially outward irradiation are primarily the x-rays 72 emitted by the target 40 in the radially outward direction.

Regardless of electron emission direction, the x-ray device 10 may be configured, tailored, and/or optimized for its primary intended use and/or irradiation direction to improve the performance and/or characteristics (e.g., enhanced structural integrity, lower weight, reduced production cost) of the x-ray device 10.

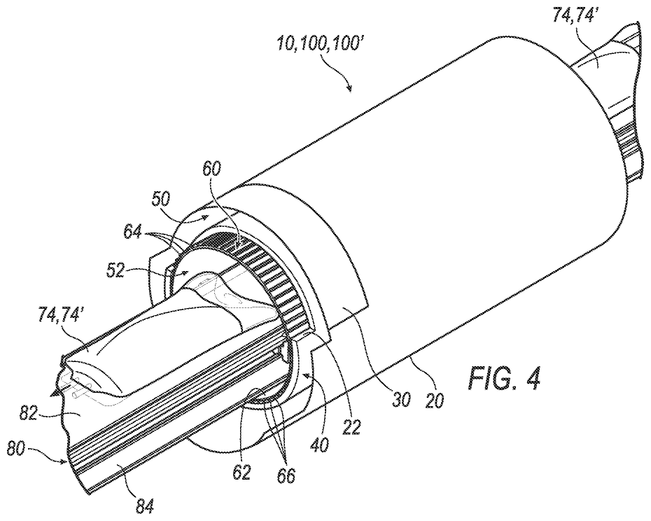

An x-ray device 10 tailored for radially inward irradiation may be considered and/or referred to as having a transmission configuration, as a transmission configuration of the x-ray device 10, and/or as a transmission x-ray device 10. For example, an exemplary x-ray device 10 configured to emit electrons in a radially inward direction (i.e., having an inward electron emission configuration 100) and tailored for radially inward irradiation (i.e., having a transmission configuration 100′) is depicted in FIG. 4, which may also be considered and/or referred to as a transmission x-ray device 10, 100, 100′ or an x-ray device 10, 100, 100′ for brevity.

An x-ray device 10 tailored for radially outward irradiation may be considered and/or referred to as having a reflection configuration, as a reflection configuration of the x-ray device 10, and/or as a reflection x-ray device 10. For example, an exemplary x-ray device 10 configured to emit electrons in a radially outward direction (i.e., having an outward electron emission configuration 200) and tailored for radially outward irradiation (i.e., having a reflection configuration 200′) is depicted in FIGS. 5A and 5B, which may also be considered and/or referred to as a reflection x-ray device 10, 200, 200′ or an x-ray device 10, 200, 200′ for brevity.

An x-ray device 10, 100 configured to emit electrons 70 in a radially inward direction (i.e., an inward electron emission x-ray device 10, 100) is generally illustrated in FIGS. 1, 2, 4, and 6. In this configuration, the first shell 20 is a radially outer shell and the second shell 22 is a radially inner shell. The second/inner shell 22, the target 40, and the cooling jacket 60 are disposed in (e.g., radially inward of) and circumferentially surrounded by the electron source 30 and the first/outer shell 20. The electron source 30 is disposed on and connected to an inner circumferential surface of the first/outer shell 20 that faces radially inward (e.g., toward the target 40 and/or the second/inner shell 22). The electron source 30 (e.g., the emitters thereof) is structured and arranged to emit electrons 70 and/or electron beams in a generally radially inward direction and/or toward the target 40. The target 40 is disposed on and connected to an outer circumferential surface of the second/inner shell 22 that faces radially outward (e.g., toward the electron source 30 and/or the first/outer shell 20). The cooling jacket 60 (e.g., the jacket shell 62) is disposed on and connected to an inner circumferential surface of the second/inner shell 22 that faces radially inward. The internal cavity 52 of the x-ray device 10, 100 is disposed radially inward of and defined by the cooling jacket 60 (e.g., the jacket shell 62).

When the x-ray device 10, 100 is used for radially inward irradiation, the utilized x-rays 72 pass through the target 40, the second shell 22, the cooling jacket 60 (e.g., the jacket shell 62 and potentially one or more support members 64), and the coolant prior to reaching the desired object 74, but do not pass through the electron source 30 nor the first shell 20 prior to reaching the object 74. As such, in a transmission configuration 100′ of the x-ray device 10, 100, the materials, composition, and/or dimensions of the second shell 22, the cooling jacket 60 (e.g., the jacket shell 62, support members 64, etc.), and the coolant are selected and/or chosen to (i) facilitate the efficient passthrough and/or transmission of x-rays 72, (ii) facilitate effective and efficient cooling of the target 40, and (iii) achieve a sufficient level of structural integrity. For example, if a pressure differential is utilized to pump and/or maintain the flow of coolant through the fluid chamber 66, the second shell 22 and the cooling jacket 60 should each have sufficient characteristics (e.g., radial thickness) and/or properties to effectively withstand and maintain the pressure differential while also providing sufficient support to the target 40 and facilitating the efficient transmission of x-rays 72 and heat. The second shell 22, the jacket shell 62, and the support members 64 of the transmission x-ray device 10, 100, 100′ include and/or are composed of one or more materials (e.g., a low-Z material and/or a low-Z metal) that mitigate and/or minimize absorption of x-rays 72 in a 10 keV to 1000 keV energy range, more specifically a 50 keV to 120 keV energy range. A materials x-ray absorption scales as exp(−μ/ρ×ρ×t) where μ/ρ is the linear mass attenuation coefficient, ρ is the material density and is the thickness. Low-Z materials and/or metals have been found to be poor absorbers of x-rays 72 in the 10 keV to 1000 keV energy range and/or the 50 keV to 120 keV energy range. In examples, the second shell 22, the jacket shell 62, and the support members 64 include and/or are composed of aluminum, which is a low-Z material and also has a high thermal conductivity to enhance cooling efficiency of the target 40. The dimensions (e.g., radial thickness) of the second shell 22 and the cooling jacket 60 (e.g., the jacket shell 62, fluid chamber 66, etc.) are relatively small and/or are as small as possible without compromising structural integrity to improve x-ray transmission. In one example, the second shell 22 is composed of aluminum and has a radial thickness of 2 mm. Generally speaking, the first shell 20 of the transmission x-ray device 10, 100, 100′ is larger and/or thicker (e.g., relative to the second shell 22 and/or relative to the first shell 20 of the reflection configuration of the x-ray device 10, 100) to increase its strength, rigidity, etc., provide greater support to the electron source 30 and/or other components, and/or to improve overall durability and mechanical robustness of the transmission x-ray device 10, 100, 100′. The first shell 20 and/or the electron source 30 of the transmission x-ray device 10, 100, 100′ may include and/or be composed of a variety of different materials since they are not passed through by the utilized x-rays 72. In one example, the first shell 20 includes and/or is composed of one or more materials that absorb x-rays 72 and/or that block, dampen, and/or mitigate the transmission of x-rays 72 (e.g., lead) to limit and/or restrict transmission of x-rays 72 into the surrounding environment of the x-ray device 10, 100, 100′.

In application, 120 keV is a typical voltage for small-diameter cylindrical structures that may be used in, for example, the oil and gas industry for downhole inspection. When considering food irradiation on conveyers, blood irradiation, higher kV may be preferred since pint blood containers (plastic bags) need to be penetrated to do the work of the irradiation.

When the x-ray device 10, 100 is used for radially outward irradiation, the utilized x-rays 72 pass through the electron source 30 and the first shell 20 prior to reaching the desired object 74, but do not pass through the target 40, the second shell 22, the cooling jacket 60, nor the coolant prior to reaching the object 74. As such, in a reflection configuration of the x-ray device 10, 100, the materials, composition, and/or dimensions of the electron source 30 (e.g., the emitters) and the first shell 20 are selected and/or chosen to (i) facilitate the efficient passthrough and/or transmission of x-rays 72 and (ii) achieve a sufficient level of structural integrity. The emitters of the electron source 30, for example, are carbon nanotube emitters due to their largely carbon construction, which reduces and/or minimizes x-ray absorption by the emitters and/or the electron source 30. The first shell 20 includes and/or is composed of one or more materials (e.g., a low Z-material and/or a low-Z metal) that mitigate and/or minimize absorption of x-rays 72 in a 10 keV to 1000 keV energy range, more specifically a 50 keV to 120 keV energy range. Generally speaking, the dimensions (e.g., radial thickness) of the electron source 30 and the first shell 20 of the reflection configuration of the x-ray device 10, 100 are also relatively small and/or as small as possible without compromising structural integrity to improve x-ray transmission. The second shell 22, jacket shell 62, and/or support members 64 of the reflection configuration of the x-ray device 10, 100 are larger and/or thicker (e.g., relative to the first shell 20 and/or relative to the corresponding elements of the transmission configuration 100′ of the x-ray device 10, 100) to increase strength, rigidity, etc. and/or to provide greater support to other elements of the x-ray device 10, 100. The size and dimensions of the fluid chamber 66 are also larger (e.g., relative to the transmission configuration 100′ of the x-ray device 10, 100) to improve cooling efficiency. The materials and/or composition of the second shell 22, the cooling jacket 60, and/or the coolant of the reflection configuration of the x-ray device 10, 100 are selected to (i) facilitate efficient and effective cooling of the target 40 and (ii) provide a sufficient or desired level of support to the target 40 and/or one or more other elements. The second shell 22 and/or the cooling jacket 60 include and/or are composed of aluminum, for example, which has good structural qualities and also high heat conductivity to facilitate cooling of the target 40.

An x-ray device 10, 200 configured to emit electrons 70 in a radially outward direction (i.e., an outward electron emission x-ray device 10, 200) is generally illustrated in FIGS. 3 and 5. In this configuration, the first shell 20 is a radially inner shell and the second shell 22 is a radially outer shell. The first/inner shell 20 and the electron source 30 are disposed in (e.g., radially inward of) and circumferentially surrounded by the second/outer shell 22, the target 40, and the cooling jacket 60. The electron source 30 is disposed on and connected to an outer circumferential surface of the first/inner shell 20 that faces radially outward (e.g., toward the target 40 and/or the second/outer shell 20). The electron source 30 (e.g., the emitters thereof) is structured and arranged to emit electrons 70 and/or electron beams in a generally radially outward direction and/or toward the target 40. The internal cavity 52 of the x-ray device 10, 200 is disposed radially inward of and defined by the first/inner shell 20. The target 40 is disposed on and connected to an inner circumferential surface of the second/outer shell 22 that faces radially inward (e.g., toward the electron source 30 and/or the first/inner shell 20). The cooling jacket 60 (e.g., the jacket shell 62) is disposed on and connected to an outer circumferential surface of the second/outer shell 22 that faces radially outward.

When the x-ray device 10, 200 is used for radially inward irradiation, the utilized x-rays 72 pass through the electron source 30 and the first shell 20 prior to reaching the desired object 74, but do not pass through the target 40, the second shell 22, the cooling jacket 60, nor the coolant prior to reaching the object 74. As such, in a transmission configuration of the x-ray device 10, 200, the materials, composition, and/or dimensions of the electron source 30 (e.g., the emitters) and the first shell 20 are selected and/or chosen to (i) facilitate the efficient passthrough and/or transmission of x-rays 72 and (ii) achieve a sufficient level of structural integrity. The emitters of the electron source 30, for example, are carbon nanotube emitters due to their largely carbon construction, which reduces and/or minimizes x-ray absorption by the emitters and/or the electron source 30. The first shell 20 includes and/or is composed of one or more materials (e.g., a low Z-material and/or a low-Z metal) that mitigate and/or minimize absorption of x-rays 72 in a 10 keV to 1000 keV energy range, more specifically a 50 keV to 120 keV energy range. Generally speaking, the dimensions (e.g., radial thickness) of the electron source 30 and the first shell 20 of the transmission configuration of the x-ray device 10, 200 are also relatively small and/or as small as possible without compromising structural integrity to improve x-ray transmission. The second shell 22, jacket shell 62, and/or support members 64 of the transmission configuration of the x-ray device 10, 200 are larger and/or thicker (e.g., relative to the first shell 20 and/or relative to the corresponding elements of the reflection configuration 200′ of the x-ray device 10, 200) to increase strength, rigidity, etc. and/or to provide greater support to other elements of the x-ray device 10, 200. The size and dimensions of the fluid chamber 66 are also larger (e.g., relative to the reflection configuration 200′ of the x-ray device 10, 200) to improve cooling efficiency of the target 40. The materials and/or composition of the second shell 22, the cooling jacket 60, and/or the coolant of the transmission configuration of the x-ray device 10, 200 are selected to (i) facilitate efficient and effective cooling of the target 40 and (ii) provide a sufficient or desired level of support to the target 40 and/or one or more other elements. The second shell 22 and/or the cooling jacket 60 include and/or are composed of aluminum, for example, which has good structural qualities and high heat conductivity.

When the x-ray device 10, 200 is used for radially outward irradiation, the utilized x-rays 72 pass through the target 40, the second shell 22, the cooling jacket 60 (e.g., the jacket shell 62 and potentially one or more support members 64), and the coolant prior to reaching the desired object 74, but do not pass through the electron source 30 nor the first shell 20 prior to reaching the object 74. As such, in a reflection configuration 200′ of the x-ray device 10, 200, the materials, composition, and/or dimensions of the second shell 22, the cooling jacket 60 (e.g., the jacket shell 62, support members 64, etc.), and the coolant are selected and/or chosen to (i) facilitate the efficient passthrough and/or transmission of x-rays 72, (ii) facilitate effective and efficient cooling of the target 40, and (iii) achieve a sufficient level of structural integrity. For example, if a pressure differential is utilized to pump and/or maintain the flow of coolant through the fluid chamber 66, the second shell 22 and the cooling jacket 60 should each have sufficient characteristics (e.g., radial thickness) and/or properties to effectively withstand and maintain the pressure differential while also providing sufficient support to the target 40 and facilitating the efficient transmission of x-rays 72 and heat. The second shell 22, the jacket shell 62, and the support members 64 of the reflection x-ray device 10, 200, 200′ include and/or are composed of one or more materials (e.g., a low Z-material and/or a low-Z metal) that mitigate and/or minimize absorption of x-rays 72 in a 10 keV to 1000 keV energy range, more specifically a 50 keV to 120 keV energy range. For example, the second shell 22, the jacket shell 62, and the support members 64 include and/or are composed of aluminum, which is a low-Z material and has a high thermal conductivity. The dimensions (e.g., radial thickness) of the second shell 22 and the cooling jacket 60 (e.g., the jacket shell 62, fluid chamber 66, etc.) are relatively small and/or are as small as possible without compromising structural integrity to improve x-ray transmission. Generally speaking, the first shell 20 of the reflection x-ray device 10, 200, 200′ is larger and/or thicker (e.g., relative to the second shell 22 and/or relative to the first shell 20 of the transmission configuration of the x-ray device 10, 200) to increase its strength, rigidity, etc., provide greater support to the electron source 30 and/or other elements of the reflection x-ray device 10, 200, 200′, and/or to improve and/or enhance overall durability and/or mechanical robustness of the reflection x-ray device 10, 200, 200′. The first shell 20 and/or the electron source 30 of the reflection x-ray device 10, 200, 200′ may also include and/or be composed of a variety of different materials since they are not passed through by the utilized x-rays 72. For example, the first shell 20 may include and/or be composed of one or more materials that absorb x-rays 72 and/or that block, dampen, and/or mitigate the transmission of x-rays 72 therethrough (e.g., lead) to limit and/or restrict transmission of x-rays 72 through the internal cavity 52.

A close-up, partial cross-sectional view of an exemplary transmission configuration 100′ of the x-ray device 10, 100 is depicted in FIG. 4. A conveyor 80 is disposed in and extends through internal cavity 52. The conveyor 80 is configured to move and/or transport objects 74 through the internal cavity 52 for irradiation (e.g., sterilization) and may, for example, include a conveyor belt 82 on which the objects 74 are disposed during transport. The conveyor 80 (e.g., the conveyor belt 82 and support structure 84 passing through the internal cavity 52) include and/or are composed of one or more low-Z materials, such as carbon fiber, to limit, mitigate, and/or minimize x-ray absorption by the conveyor 80. The objects 74 in FIG. 4 are blood bags 74′, but the objects 74 may be any other suitable object(s) as desired. The transmission x-ray device 10, 100, 100′ and the conveyor 80 may be operated simultaneously and continuously such that x-rays 72 are continuously present in the internal cavity 52 and the objects 74 are continuously transported through the internal cavity 52. Alternatively, the transmission x-ray device 10, 100, 100′ and the conveyor 80 may be operated sequentially. For example, the conveyor 80 may be operated to transport an object 74 into the internal cavity 52 for irradiation, the transmission x-ray device 10, 100, 100′ operated to irradiate the object 74, and then the conveyor 80 operated again to transport the irradiated object 74 out of the internal cavity 52 and the next object 74 into the internal cavity 52 for irradiation. While not depicted, a transmission configuration of the x-ray device 10, 200 may be utilized in conjunction with the conveyor 80 and the objects 74, 74′ in a substantially similar manner.

An exemplary reflection configuration 200′ of the x-ray device 10, 200 is depicted in FIGS. 5A and 5B. The reflection x-ray device 10, 200, 200′ is disposed within a cavity 92 of an oil-well 90 and is being used to inspect an object 74, which is an cylindrical casing 74″ of the oil-well 90 in this example. The reflection x-ray device 10, 200, 200′ further includes dome-shaped end caps 94A, 94B disposed at and connected to opposite axial ends of the jacket shell 62. The end cap 94A is connected to a cable 96 via which the reflection x-ray device 10, 200, 200′ is suspended within the oil-well 90. A portion and/or end of the cable 96 is connected to and/or mounted on an adjustment mechanism 88 (e.g., a manual and/or motorized crank mechanism) for lowering and/or raising the x-ray device 10, 200, 200′ into, out of, and within the oil-well 90. The cable 96 includes the conductors 16A, 16B and/or the conductors 16A, 16B extend through the cable 96 and are connected to the power source 14, which is disposed outside of the oil-well 90 at surface/ground level. The cable 96 also includes tubes 98A, 98B and/or tubes 98A, 98B extend through the cable 96 and connect the fluid chamber 66 to the heat exchanger 56 and the pump 58, which are also disposed outside of the oil-well 90 at surface/ground level. Alternatively, the power source 14 is a portable power source (e.g., a battery) and the power source 14, the heat exchanger 56, the pump 58, and the tubes 98A, 98B are disposed in one or more of the end caps 94A, 94B such that the x-ray device 10, 200, 200′ is a substantially self-contained unit. While not depicted, a reflection configuration of the x-ray device 10, 100 may be utilized and/or configured in a substantially similar manner except the end caps 94A, 94B are disposed at and connected to axial opposite ends of the first shell 20 rather than the jacket shell 62.

Another configuration 100″ of the x-ray device 10, 100 is depicted in FIG. 6. The first shell 20 and the electron source 30 each have and/or define a hexagonal cross-sectional profile and/or shape. The second shell 22 and the target 40 each have and/or define a pentagonal cross-sectional profile and/or shape. The x-ray device 10, 100, 100″ does not include a cooling jacket 60. The configuration 100″ is otherwise substantially similar to the configuration of the x-ray device 10, 100 of FIG. 2. The x-ray device 10, 100, 100″ also has a transmission configuration and/or a reflection configuration in accordance with the description above.

In one example, the x-ray device 10, 100 has an operating voltage of 120 kV, a diameter of 9.5 inches at the electron source 30, an internal diameter of 4 inches at the target 40, and an axial length of 12 inches. The second shell 22 is composed of aluminum and has a radial thickness of 2 mm. The target 40 is a tungsten layer having a radial thickness of 22 μm. The target 40 is bombarded by a uniformly cylindrical distribution of 120 keV electrons during operation.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

It should be understood that a controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An x-ray device, comprising:
a target that emits x-rays when subjected to electrons;
an electron source configured to emit the electrons toward the target when a voltage is applied between the target and the electron source;
an elongated annular first shell connected to and supporting the electron source; and
an elongated annular second shell connected to and supporting the target;
wherein the first shell and the second shell are arranged one radially inside the other.

2. The x-ray device of claim 1, wherein the target is a layer of material including tungsten.

3. The x-ray device of claim 1, wherein the first shell and the second shell are arranged coaxially and concentrically.

4. The x-ray device of claim 1, wherein the electron source includes a plurality of carbon nanotube emitters.

5. The x-ray device of claim 1, further comprising an annular vacuum space defined at least partially by and between the first shell and the second shell, wherein the target and the electron source are disposed within the vacuum space.

6. The x-ray device of claim 1, wherein the first shell and the second shell each have a circular cross-sectional profile.

7. The x-ray device of claim 1, wherein the second shell is at least partially composed of aluminum.

8. The x-ray device of claim 1, further comprising a cooling jacket connected to the second shell and at least partially defining a fluid chamber through which a coolant is flowable.

9. The x-ray device of claim 8, wherein the cooling jacket and the target are disposed on radially opposite sides of the second shell.

10. The x-ray device of claim 8, wherein the cooling jacket includes an elongated annular jacket shell arranged concentrically with the second shell.

11. The x-ray device of claim 10, wherein the fluid chamber is defined by and radially between the jacket shell and the second shell.

12. The x-ray device of claim 11, wherein the cooling jacket further includes a plurality of support members disposed in the fluid chamber, the plurality of support members connected to and extending between the jacket shell and the second shell.

13. The x-ray device of claim 1, wherein the second shell and the target are disposed radially inward of and circumferentially surrounded by the first shell and the electron source.

14. The x-ray device of claim 13, wherein:
the electron source is disposed on an inner circumferential surface of the first shell; and
the target is disposed on an outer circumferential surface of the second shell.

15. The x-ray device of claim 14, further comprising a cooling jacket connected to an inner circumferential surface of the second shell, wherein a fluid chamber through which a coolant is flowable is at least partially defined by and between the cooling jacket and the second shell.

16. The x-ray device of claim 1, wherein the first shell and the electron source are disposed radially inward of and circumferentially surrounded by the second shell and the target.

17. The x-ray device of claim 16, wherein:
the electron source is disposed on an outer circumferential surface of the first shell; and
the target is disposed on an inner circumferential surface of the second shell.

18. The x-ray device of claim 17, further comprising a cooling jacket connected to an outer circumferential surface of the second shell, wherein a fluid chamber through which a coolant is flowable is at least partially defined by and between the cooling jacket and the second shell.

19. An x-ray device, comprising:
an elongated annular first shell;
an elongated annular second shell, the first shell and the second shell arranged one radially inside the other;
an annular vacuum space defined by and radially between the first shell and the second shell;
a target that emits x-rays when subjected to electrons, the target disposed in the vacuum space and connected to the second shell;
an electron source configured to emit electrons toward the target, the electron source disposed in the vacuum space and connected to the first shell;
a cooling jacket arranged on and connected to the second shell, the second shell disposed radially between and separating the target and the cooling jacket;
an annular fluid chamber through which a coolant is flowable, the fluid chamber at least partially defined by and radially between the cooling jacket and the second shell; and
an internal cavity circumferentially surrounded by the first shell, the second shell, the electron source, the target, and the cooling jacket.

20. An x-ray device, comprising:
a target that emits x-rays when subjected to electrons;
an electron source configured to emit electrons toward the target;
an elongated annular first shell connected to and supporting the electron source; and
an elongated annular second shell connected to and supporting the target;
wherein the first shell and the second shell are arranged one radially inside the other; and
wherein one of:
(i) the electron source is disposed on an inner circumferential surface of the first shell and the target is disposed on an outer circumferential surface of the second shell; and
(ii) the electron source is disposed on an outer circumferential surface of the first shell and the target is disposed on an inner circumferential surface of the second shell.
